(19) United States
(12) Patent Application Publication
(10) Pub. No.: US 2012/0140130 A1
(43) Pub. Date: Jun. 7, 2012

(54) AUTOSTEREOSCOPIC IMAGE DISPLAY DEVICE AND FILM FOR AUTOSTEREOSCOPIC IMAGE DISPLAY DEVICE

(75) Inventor: Yujiro YANAI, Kanagawa (JP)

(73) Assignee: FUJIFILM Corporation, Tokyo (JP)

(21) Appl. No.: 13/305,397

(22) Filed: Nov. 28, 2011

(30) Foreign Application Priority Data
Dec. 2, 2010 (JP) 2010-269816

(51) Int. Cl. G02F 1/1335; G02B 27/22

(52) U.S. Cl. 349/15; 359/463

(57) ABSTRACT

A autostereoscopic image display device is provided in which a moiré pattern (interference fringe) or glare due to brightness and darkness of the pixels is suppressed without deteriorating the stereoscopic effect. The autostereoscopic image display device includes a surface member, a lenticular layer, and a display unit sequentially from a viewing side thereof. The surface haze of the surface member is in the range of 1% to 35% and the internal haze is in the range of 0% to 30%.

### BACKGROUND OF THE INVENTION

1. Field of the Invention

The present invention relates to a technique of suppressing a moiré pattern (interference fringe) or glare due to brightness and darkness of the pixels, which occurs in a autostereoscopic image display device having a lenticular layer, by the use of a surface member without deteriorating the stereoscopic effect.

2. Description of the Related Art

As a autostereoscopic image display device, a display device has been known which enables a stereoscopic image to be viewed in a specific observation range by separating an image into a right-eye image and a left-eye image through the use of a lenticular lens, as disclosed in JP4196889B. The lenticular lens is formed from a sheet-like lens or by installing a liquid crystal layer making liquid crystal into a lens shape with an application of a voltage or the like.

In the stereoscopic image display of such a lenticular type, a moiré pattern is recognized due to various reasons, as disclosed in SID2009 31.3, “Reduction and Measurement of 3D Moire Caused by Lenticular Sheet and Backlight”, S. Uehara et al. Since black matrices present between pixels block light but pixels and black matrices are appear enlarged in the observation range, the brightness and darkness thereof is recognized as glare. This glare is particularly marked in white state.

To solve the a moiré pattern, JP1997-133893A (JP-H09-133893A) and JP2005-172969A disclose that a diffuser (diffusing body) is disposed on the viewing side of the lenticular lens.

JP2005-316372A discloses that a diffusing plate is disposed between a display unit and a lenticular layer.

### SUMMARY OF THE INVENTION

However, JP1997-133893A (JP-H09-133893A) does not disclose any condition (for example, a haze) causing the moiré pattern to disappear but discloses only a layer structure in the embodiments, and does not mention a stereoscopic effect.

It has also been known that when a diffusing body is disposed in front of a lenticular lens, the stereoscopic effect of a stereoscopic image is lost and the image becomes a planar image (see JP2001-330713A). Hitherto, the compatibility of the stereoscopic effect and the suppression of glare have not been sufficiently studied.

The invention is made to solve the above-mentioned problems. An advantage of some aspects of the invention is that it provides a autostereoscopic image display device which can suppress a moiré pattern (interference fringe) or glare due to brightness and darkness of the pixels, which occurs in the autostereoscopic image display device having a lenticular layer, through the use of a surface member without deteriorating the stereoscopic effect.

The above-mentioned advantage of the invention can be achieved by the following means.

(1) A autostereoscopic image display device including a surface member, a lenticular layer, and a display unit sequentially from the viewing side, wherein the surface haze of the surface member is in the range of 1% to 35% and the internal haze is in the range of 0% to 30%.

(2) The autostereoscopic image display device according to (1), wherein the total haze of the surface member is in the range of 1% to 45%.

(3) The autostereoscopic image display device according to (1) or (2), wherein the surface haze of the surface member is in the range of 3% to 25% and the internal haze is in the range of 0% to 15%.

(4) The autostereoscopic image display device according to any one of (1) to (3), wherein the surface member has surface unevenness.

(5) The autostereoscopic image display device according to any one of (1) to (4), wherein the surface member has a scattering structure including a binder and at least one kind of particles with a diameter of 1 to 20 μm and the difference in refractive index between the binder and the particles is in the range of 0.0 to 0.2.

(6) The autostereoscopic image display device according to any one of (1) to (4), wherein the surface member has a sea-island structure in which the difference in refractive index between domains due to phase separation is in the range of 0.02 to 0.1.

(7) The autostereoscopic image display device according to any one of (1) to (6), wherein the surface member further has a functional layer.

(8) The autostereoscopic image display device according to (7), wherein the functional layer is at least one layer selected from the group consisting of an antireflection layer, an hardcoat layer, an antifouling layer, and an antistatic layer.

(9) The autostereoscopic image display device according to any one of (1) to (6), wherein the surface member is an optical film.

(10) The autostereoscopic image display device according to (9), wherein the display unit includes a liquid crystal cell and a polarizing plate at least on the viewing side of the liquid crystal cell, and the optical film is a protective film of the polarizing plate on the viewing side.

(11) A film for the autostereoscopic image display device including the optical film according to (9) or (10), wherein the optical film is a layer obtained by forming a scattering structure including a binder and at least one kind of particles with a diameter of 1 to 20 μm on a support member by coating.

(12) The film for the autostereoscopic image display device according to (11), wherein the support member includes at least one selected from the group consisting of cellulose acylate, acrylic resin, polyester, and cycloolefin polymer.

(13) The film for the autostereoscopic image display device according to (11) or (12), wherein the optical film further has a functional layer.

(14) The film for the autostereoscopic image display device according to (13), wherein the functional layer is at least one layer selected from the group consisting of an antireflection layer, an hardcoat layer, an antifouling layer, and an antistatic layer.

According to the invention, it is possible to provide an autostereoscopic image display device in which a moiré pattern (interference fringe) or glare due to brightness and darkness of the pixels is suppressed without deteriorating the stereoscopic effect.

### DESCRIPTION OF THE PREFERRED EMBODIMENTS

Hereinafter, the invention will be described in more detail. In this specification, when a numerical value represents a physical property value or a characteristic value, the description of “numerical value 1 to numerical value 2” means that the numerical value is “equal to or greater than numerical value 1 and equal to or less than numerical value 2”.

Stereoscopic Image Display Device

A stereoscopic image display device provides a stereopsis based on a human binocular parallax (difference in image position between the right eye and the left eye. A type using glasses and a glasses-free type are known as means for providing the parallax.

For example, the scheme based on a pair of glasses is a method of dividing images prepared for the right eye and the left eye so as to reach only the corresponding eyes. Examples of well-known schemes thereof includes an anaglyph scheme of showing red and blue images through the use of red-blue 3D glasses, a polarization scheme showing images through the use of polarizing glasses or polarizing filters, and an active shutter scheme of switching right and left images at a high speed, switching right and left shutters of the glasses in synchronization thereof, and showing the right and left images in a time-division manner, and the like.

On the other hand, a method of forming optical paths beyond the reach of the respective eyes is known as a method of achieving the stereopsis, and examples thereof include a parallax barrier method and a lenticular lens method. The parallax barrier method is a method of showing a right-eye image and a left-eye image through dedicated slits, respectively, and the lenticular lens method is a method of showing the right and left images through the use of a sequence of semi-cylindrical (semi-ellipsoidal) lenses (a lenticular lens or a lenticular layer, which is also referred to as a “lenticular layer”).

The autostereoscopic image display device according to the invention employs the method based on a lenticular layer among the methods.

That is, the autostereoscopic image display device according to the invention includes a surface member, a lenticular layer, and a display unit sequentially from a viewing side, and the surface haze of the surface member is in the range of 1% to 35% and the internal haze is in the range of 0% to 30%. By disposing the surface member having the specific haze value on the viewing side of the lenticular layer, it is possible to prevent a moire pattern or a glare due to the brightness and darkness based on periodic component of the moiré pattern particularly at the time of white state or display of a bright image, without deteriorating a stereoscopic effect of an image.

Lenticular Layer

Since the lenticular layer include plural pixels in a repeating unit of lenticular lenses and one pixel among the plural pixels can be basically observed in a specific direction, it is possible to provide plural images by changing the observation direction in the repeating unit of lenticular lenses.

For the purpose of manufacturing convenience or prevention of stray light, structural elements such as black matrices, interconnections, and transistors are regularly arranged between the pixels in the repeating unit.

It is clear as the result of study that the structural elements are subjected to interference, emphasis, and enlargement in a specific direction through the use of the lenticular lenses, thereby causing glare. This glare can be prevented without deteriorating a stereoscopic effect by the combination with the surface member having a specific haze value according to the invention.

The lenticular lens used in the invention is not particularly limited, and existing lenticular lenses can be used.

Surface Member

The surface member in the invention has a surface haze of 1% to 35% and an internal haze of 0% to 30%. The haze values can be achieved, for example, by causing the surface member to have a scattering structure. The surface member may be formed directly on the lenticular lens surface of the lenticular layer or may be provided as a member other than the lenticular layer. By providing the surface member as another member, it is possible to reduce limitations in manufacturing suitability and to provide the functions of the present application to existing products, which is desirable.

In the invention, the scattering structure for achieving the above-mentioned haze values can be roughly classified into a “surface scattering structure” and an “internal scattering structure”. The degrees of light scattering due to these two types of scattering structures are the “surface haze” and the “internal haze”, respectively, which can be measured by the following measuring method.

Haze Measuring Method

(1) The total haze value (H) of the surface member is measured based on JIS-K7136.

(2) Several droplets of silicone oil are added to the front surface and the rear surface of the surface member, the resultant is interposed between two glass plates (Micro Slide Glass No. S9111 made by MATSUNAMI GLASS Ind., Ltd.) with a thickness of 1 mm, two glass plates and the resultant surface member completely come in close contact with each other, the haze is measured in a state where the surface haze is removed, and the value obtained by subtracting a haze, which is separately measured in a state where only the silicone oil is interposed between two glass plates, from the measured haze is calculated as the internal haze (Hi) of the surface member.

The value obtained by the internal haze (Hi) calculated in (2) from the total haze (H) measured in (1) is calculated as the surface haze (Hs).

In the invention, the total haze (=surface haze+internal haze) of the surface member is preferably in the range of 1% to 45%. Regarding the surface haze and the internal haze, it is preferable that the surface haze is in the range of 3% to 25% and the internal haze is in the range of 0 to 15%, and it is more preferable that the surface haze is in the range of 5% to 20% and the internal haze is in the range of 0% to 10%.

Scattering Structure

The “surface haze” obtained through the above-mentioned measuring method is based on a “surface scattering structure” and attributes to the scattering (the surface scattering) due to the surface texture.

On the other hand, the “internal haze” is based on an “internal scattering structure” and attributes to the scattering (the internal scattering) due to reflection or refraction at boundaries of a material and a binder or the like, in which the material other than the binder exists in a main medium (hereinafter, referred to as a “binder”) of the scattering structure.

Control of Surface Scattering Structure

The scattering in the surface greatly depends on the shape of light incidence and exit surfaces, particularly, an exit surface.

Accordingly, a method of controlling surface unevenness known as an anti-glare structure can be applied to the control of the surface scattering structure and the surface member according to the invention preferably has surface unevenness.

The glare of which the improvement is intended through the use of the anti-glare structure in the related art is due to reflected light. On the contrary, since the glare of which the improvement is intended in the invention is glare based on transmitted light due to the internal structure of the stereoscopic image display device, the target to be improved is greatly different.

As the method of controlling the surface unevenness, a shaping method based on die-pressing (also referred to as embossing), a method of forming unevenness on the surface due to particle shapes by adding particles to the binder constituting the scattering structure, a method of dissolving or dispersing the binder constituting the scattering structure in a mixed solvent of a good solvent and a poor solvent, forming the domain of the poor solvent due to the phase separation at the time of drying, and causing the domain of the poor solvent to prevent the formation of flat portions to form concave portions, and the like are known.

Examples of the shaping method based on die-pressing include a method of forming an uneven shape by pressing an embossing plate having the inverted shape of the uneven shape to be formed against the structure to transfer the inverted shape of the embossing plate to the structure. Examples of the shaping method include a method of deforming the structure by pressurization by pressing an embossing plate, a method of pressing an embossing plate against a molten surface and cooling the resultant to fix the shape, a method of pressing a transparent film-like embossing plate against a coating formed of an UV-curable polymerizable composition and applying UV light from the rear surface of the embossing plate to fix the shape through the UV curing, or combinations thereof.

Specifically, the descriptions of JP1997-193332A (JP-H9-193332A), JP2005-070436A, JP2005-234554A, JP2006-062240A, and WO2006/088203 can be carried out for reference.

An example of the method using addition of particles includes a method of adding particles with a diameter of 1 to 20 μm to a polymerizable composition serving as a binder, so that the thickness of the parts other than the vicinities of the parts in which the particles are present decreases due to volatilization of the solvent or polymerization shrinkage after the coating with the polymerizable composition and the polymerizable composition deposited on the particles or the particles themselves maintain the thickness in the parts where the particles are present, whereby the variation in thickness serves as unevenness to form the surface structure.

The shape thereof can be controlled depending on the size of the added particles, the type of the binder, and the film-forming conditions.

Specifically, the descriptions of JP2005-316450A, JP2006-293334A, JP2008-262190A, and JP2010-085759A can be carried out for reference.

An example of the method of using the phase separation includes a method of adjusting the polymerizable composition by the use of a phase-insoluble solvent having a different dielectric constant, causing the phase-insoluble solvent to form a sea-island structure due to the phase separation, and causing the domain of the solvent constituting an island to remain in a surface shape to form a concave portion.

Specifically, the method described in Japanese Patent Application No. 2009-229023.

Control of Internal Scattering Structure

The scattering in the scattering structure greatly depends on the material or structure of the scattering structure. Accordingly, a control method using a diffusing sheet or the like can be applied to the control of the internal scattering structure.

Examples of the method of controlling the internal nature and state include the phase separation or the formation of micro defects due to the addition of particles or the blending of polymers.

As the method based on the addition of particles, the same method as the method of controlling the surface scattering structure can be used.

By causing the added particles to have a difference in refractive index from the binder, it is possible to cause the refraction or reflection on the particle surfaces in the scattering structure, thereby causing the internal scattering. On the other hand, when there is no difference between the refractive index of the particles and the refractive index of the binder, the internal scattering such as refraction or reflection hardly occurs and thus only the surface scattering can be controlled. A preferable example of the surface example of the invention is a scattering structure including a binder and particles with a diameter of 1 to 20 μm, in which the difference in refractive index between the binder and the particles is in the range of 0.0 to 0.2.

The diameter of the particles is more preferably in the range of 2 to 15 μm and still more preferably in the range of 3 to 10 μm. The difference in refractive index between the binder and the particles is more preferably in the range of 0.0 to 0.15.

When plural types of polymers insoluble in each other are mixed to form a film, parts of the polymers cause the phase separation to form a sea-island structure. The island parts exhibits the same behavior as the particles in the method based on the addition of particles, thereby forming the internal scattering structure.

A specific method thereof is described in JP2008-058723A or the like.

The sea-island structure based on the phase separation serves as both the surface scattering structure and the internal scattering structure. In this case, the difference in refractive index between the domains is preferably in the range of 0.005 to 0.1, more preferably in the range of 0.01 to 0.15, and still more preferably in the range of 0.02 to 0.1.

By forming the solvent used as the coating liquid by the use of plural types of solvents having different boiling points and intentionally foaming the coating liquid based on the difference in volatilization temperature to cause bubbles or by applying a stress based on stretch or the like to a crystalline resin, micro defects such as “crazes” or “cracks” may be intentionally created. Since the micro defects have a different refractive index from that of the surrounding binder polymer, the micro defects can be used as the internal scattering factors.

Specifically, examples thereof include methods described in JP1999-320670A (JP-H11-320670), JP2008-296421, and the like.

Among the above-mentioned, the addition of particles is preferable for the reason of easy design of the surface scattering structure and the internal scattering structure and the high manufacturing suitability. The scattering structure based on the addition of particles can be formed as a light scattering layer including the binder and the particles.

The thickness of the light scattering layer is preferably in the range of 1 μm to 30 μm and more preferably in the range of 3 μm to 20 μm, from the viewpoints of the application of a hard coating property and the suppression of occurrence of a curl and deterioration in brittleness.

The binder of the light scattering layer is preferably a polymer having a saturated hydrocarbon chain or a polyether chain as a main chain and more preferably a polymer having a saturated hydrocarbon chain as a main chain. The binder polymer preferably has a cross-linking structure. A polymer of an ethylenic unsaturated monomer can be preferably used as the binder polymer having a saturated hydrocarbon chain as a main chain. A preferable example of the binder polymer having a saturated hydrocarbon chain as a main chain and having a cross-linking structure is a (co)polymer of a monomer having two or more ethylenic unsaturated groups. To cause the binder polymer to have a high refractive index, a polymer having an aromatic cycle or at least one atom selected from halogen atoms other than fluorine, a sulfur atom, a phosphorus atom, and a nitrogen atom in the monomer structure may be selected.

Examples of the monomer having two or more ethylenic unsaturated groups include esters of polyhydric alcohol and (meth)acrylate (such as ethyleneglycol di(meth)acrylate, butanediol di(meth)acrylate, hexanediol di(meth)acrylate, 1,4-cyclohexane dicarylate, pentaerythritol tetra(meth)acrylate, pentaerythritol tri(meth)acrylate, trimethylolpropane tri(meth)acrylate, trimethylolethane tri(meth)acrylate, dipentaerythriol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate, and polyester polyacrylate), modified products of the ethylene oxide, vinylbenzene and derivatives thereof (such as 1,4-divinylbenzene, 4-vinyl benzoate-2-acryloyl ethylester, and 1,4-divinylcyclohexanone), vinylsulfone (such as divinylsulfone), acrylamide (such as methylene bisacrylamide), and methacrylamide. Two or more monomers of these monomers may be used together.

Specific examples of the high-refractive-index monomer include bis(4-methacryl thiophenyl)sulfide, vinylnaphthalene, vinylphenyl sulfide, and 4-methacryloxyphenyl-4′-methoxyphenyl thioether. Two or more monomers of these monomers may be used together.

A preferable example of the polymer having a polyether chain as a main chain is a ring-opened polymer of a polyfunctional epoxy compound.

When particles are added to the light scattering layer, particles of an inorganic compound or resin particles with a diameter (an average diameter) of 1 to 20 μm can be used.

Specific examples of the particles include inorganic compound particles such as silica particles and TiO₂ particles and resin particles such as acrylic particles, cross-linked acrylic particles, polystyrene particles, cross-linked styrene particles, melamine resin particles, and benzoguanamine resin particles. Among these, cross-linked styrene particles, cross-linked acrylic particles, cross-linked acrylstyrene particles, and silica particles can be preferably used. The shape of particles may be spherical or irregular.

Two or more types of particles having different diameters may be used together. The particles with the larger diameter give a light scattering property to the surface and the particles with the smaller diameter having a different refractive index give the light scattering property or a different optical characteristic to the inside.

The particle diameter distribution of the particles is the most preferably singly dispersed and the particle diameters of the particles are preferably closer to each other. For example, when particles having a particle diameter larger by 20% than the average particle diameter are defined as coarse particles, the ratio of the coarse particles is preferably equal to or less than 1% than the total number of particles, more preferable equal to or less than 0.1%, and still more preferable equal to or less than 0.01%. Matte particles having such a particle diameter distribution can be obtained by classification after a typical synthesis reaction and a matte material having a more preferable distribution can be obtained by raising the classification number or strengthening the intensity of classification. The average particle diameter in this specification can be calculated, for example, as follows. First, the size distribution of particles is measured by the use of a Coulter counter method. Then, the measured distribution is converted into the particle number distribution and the average particle diameter is calculated from the obtained particle distribution.

Optical Film

The surface member according to the invention may have an optical function (such as an antirefiection function) in addition to the light scattering function based on the scattering structure. For this purpose or other purposes, the surface member may have a structure other than the scattering structure.

When the surface member has an optical function, the surface member is preferably formed of an optical film having a film shape.

Support

The surface member having the scattering structure may be directly formed on lenticular lenses of the lenticular layer, but when it is provided as a separate member, a support on which the scattering structure can be scattered can be used.

The material of the support is not particularly limited as long as it has transparency and self-supporting ability. When it is manufactured as a film, the support is preferably formed of a material selected from the group consisting of cellulose acylate, acrylic resin, polyester, and cycloolefin polymer, from the view of processing suitability thereof.

Regarding the optical performance, it is preferable that the support has high transparency and a low internal haze. When the support has the internal haze, the internal haze of the surface member as a whole increases. Accordingly, the low internal haze facilitates the design of the scattering structure.

In addition to the self-supporting ability, the support preferably has appropriate mechanical performance and high adhesion to an adjacent layer when a stacked body is formed.

Functional Layer

Since the surface member according to the invention is used as the outermost surface of the image display device, the surface member may include various functional layers, a layer together performing the functions may be stacked thereon, or the surface member itself may have the functions.

Examples of the functional layer include an antireflection layer, an hardcoat layer, an antifouling layer, and an antistatic layer. The layers including the light scattering layer may have the function of another layer.

Antireflection Layer

Low-Refractive-Index Layer

The surface member according to the invention may have an antireflection layer (such as a low-refractive-index layer) on the light scattering layer.

The low-refractive-index layer is preferably formed as a thin layer with a thickness of 200 nm or less. The low-refractive-index layer has only to be formed with about a quarter of a design wavelength in an optical layer thickness. However, in the case of a single-layered thin film interference type in which the antireflection is achieved by a single low-refractive index layer which is the simplest structure, the reflectance thereof satisfies 0.5% or less. However, since there is no practical low-refractive-index material having a neutral color, a high abrasion-resistance property, a chemical-resistance property, and a weather-resistance property, a multi-layered thin film interference type antireflection film achieving the antireflection through the optical interference of multiple layers, such as a two-layered thin film interference type in which a high-refractive-index layer is formed between the support and the low-refractive-index layer or a three-layered thin film interference type in which a medium-refractive-index layer and a high-refractive-index layer are sequentially formed between the support and the low-refractive-index layer, can be used when the lower reflectance is necessary.

In this case, the refractive index of the low-refractive-index layer is preferably in the range of 1.30 to 1.51, more preferably in the range of 1.30 to 1.46, and still more preferably in the range of 1.32 to 1 38. By setting the refractive index to the above-mentioned range, the reflectance can be suppressed and the film strength can be maintained, which is preferable. Regarding the method of forming the low-refractive-index layer, a transparent thin film of inorganic oxide may be used through the use of a chemical vapor deposition (CVD) method or a physical vapor deposition (PVD) method, particularly, a vacuum vapor deposition method or a sputtering method which is a kind of physical vapor deposition method, but an all-wet coating method using a low-refractive-index layer composition can be preferably used.

The low-refractive-index layer is not particularly limited, as long as it has the above-mentioned refractive index range, known materials can be used as the constituent components thereof. Specifically, the compositions containing fluorine-curable resins and inorganic particles described in JP2007-298974A or a low-refractive-index coating containing hollow silica particles described in JP2002-317152A, JP2003-202406A, and JP2003-292831A can be used very suitably.

High-Refractive-Index Layer and Medium-Refractive-Index Layer

The refractive index of the high-refractive-index layer is preferably in the range of 1.65 to 2.20 and more preferably in the range of 1.70 to 1.80. The refractive index of the medium-refractive-index layer is adjusted to be a value between the refractive index of the low-refractive-index layer and the refractive index of the high-refractive-index layer. The refractive index of the medium-refractive-index layer is preferably in the range of 1.55 to 1.65 and more preferably in the range of 1.58 to 1.63.

Regarding the method of forming the high-refractive-index layer and the medium-refractive-index layer, a transparent thin film of inorganic oxide may be used through the use of a chemical vapor deposition (CVD) method or a physical vapor deposition (PVD) method, particularly, a vacuum vapor deposition method or a sputtering method which is a kind of physical vapor deposition method, but an all-wet coating method can be preferably used.

The medium-refractive-index layer and the high-refractive-index layer are not particularly limited, as long as they are the layers having the above-mentioned refractive index ranges. Known materials can be used as the constituent components and specific examples thereof are described in paragraphs [0074] to [0094] of JP2008-262187A.

Hardcoat Layer

An hardcoat layer can be preferably formed to improve the resistance to the scratch or the like of the surface of the surface member. The specific configuration of the hardcoat layer is described, for example, in JP2009-098666A or JP2010-085760A, which can be used in the invention.

Method of Forming Surface Member

In the invention, the surface member having the light scattering layer containing a binder and at least one kind of particles with a diameter of 1 to 20 μm as a scattering structure on the support can be formed, for example, by coating the support with a coating liquid including the compound constituting the binder and the particles.

Examples of the compound constituting the binder include the above-mentioned polymers of ethylenic unsaturated monomers or the ring-opened polymers of polyfunctional epoxy compounds.

The polymerization of the monomer having an ethylenic unsaturated group can be carried out through the irradiation with ionizing radiation or the heating in the presence of an optical radical initiator or a thermal radical initiator.

Therefore, the light scattering layer can be formed by preparing a coating liquid including the monomer having an ethylenic unsaturated group, the optical radical initiator or the thermal radical initiator, and the particles, coating the support with the coating liquid, and curing the coating liquid through the polymerization reaction using the ionizing radiation or the heat. Known agents can be used as the optical radical initiator and the like.

The ring-opening polymerization of the poly-functional epoxy compounds can be carried out through the irradiation with ionizing radiation or the heating in the presence of a photo-acid-generating agent or a thermal-acid-generating agent.

Therefore, the light scattering layer can be formed by preparing a coating liquid including the poly-functional epoxy compound, the photo-acid-generating agent or the thermal-acid-generating agent, and the particles, coating the support with the coating liquid, and curing the coating liquid through the polymerization reaction using the ionizing radiation or the heat.

A cross-linking functional group may be introduced into the polymer using a monomer having a cross-linking functional group instead of or in addition to the monomer having two or more ethylenic unsaturated groups and a cross-linking structure may be introduced into the binder polymer through the reaction of the cross-linking functional group.

Examples of the cross-linking functional group include an isocyanate group, an epoxy group, an adizirine group, an oxazoline group, an aldehyde group, a carbonyl group, a hydrazine group, a carboxyl group, a methylol group, and active methylene group. Vinyl sulfonate, acid anhydride, cyanoacrylate derivatives, melamine, ethylenated methylol, ester, and metal alkoxide such as urethane and tetramethoxy silane can be used as the monomer for introducing the cross-linking structure. A functional group exhibiting a cross-linking property as the result of a decomposition reaction, such as a blocked isocyanate group, may be used. That is, the cross-linking functional group in the invention may not exhibit the reactivity directly but may exhibit the reactivity as the result of a decomposition reaction.

The binder polymer having the cross-linking functional group can form the cross-linking structure by heating the binder polymer after the coating.

Surfactant

Particularly, to guarantee the planar uniformity such as coating unevenness, drying unevenness, and point defects, it is preferable that the coating liquid for forming the light scattering layer include one or both of a fluorine-based surfactant and a silicone-based surfactant. Particularly, the fluorine-based surfactant exhibits the effect of improving the planar defects such as coating unevenness, drying unevenness, and point defects even with a small addition, and is thus preferably used. By giving high-speed coating suitability while enhancing the planar uniformity, it is intended to raise productivity. Preferable examples of the fluorine-based surfactant include compounds described in paragraphs 0049 to 0074 of JP2007-188070A.

The addition of the surfactant (particularly, fluorine-based polymer) used as the coating liquid for forming the light scattering layer is preferably in the range of 0.001 to 5 wt %, more preferably in the range of 0.005 to 3 wt %, and still more preferably in the range of 0.01 to 1 wt %. The effect is sufficient when the addition of the surfactant is equal to or more than 0.001 wt %, and the drying of the coating film is sufficient when the addition of the surfactant is equal to or less than 5 wt %, whereby it is possible to obtain an excellent performance (for example, reflectance and abrasion resistance) as a coating film.

Organic Solvent

An organic solvent may be added to the coating liquid for forming the light scatting layer.

Examples of the organic solvent include alcohols such as methanol, ethanol, n-propanol, isopropanol, n-butanol, isobutanol, secondary butanol, tertiary butanol, isoamylalcohol, 1-pentanol, n-hexanol, and methylamylalcohol, ketones such as methylisobutyl ketone, methylethyl ketone, diethyl ketone, acetone, cyclohexanone, and diacetone alcohol, esters such as methyl acetate, ethyl acetate, n-propyl acetate, isopropyl acetate, isobutyl acetate, n-butyl acetate, isoamyl acetate, n-amyl acetate, methyl propionate, ethyl propionate, methyl butyrate, ethyl butyrate, methyl lactate, and ethyl lactate, ethers or acetals such as 1,4-dioxane, tetrahydrofuran, 2-methyfuran, tetrahydropyran, and diethyl acetal, hydrocarbons such as hexane, heptanes, octane, isooctane, ligroin, cyclohexane, methylcyclohexane, toluene, xylene, ethyl benzene, styrene, and divinylbenzene, halogen hydrocarbons such as carbon tetrachloride, chloroform, methylene chloride, ethylene chloride, 1, 1,1,-trichloroethane, 1,1,2-trichloroethane, trichloroethylene, tetrachloroethylene, and 1,1,1,2-tetrachloroethane, polyhydric alcohols and derivatives thereof such as ethylene glycol, ethylene glycol monomethylethyl, ethylene glycol monoethyl ether, ethylene glycol monoacetate, diethylene glycol, propylene glycol, dipropylene glycol, butanediol, hexylene glycol, 1,5-pentanediol, glycerin monoacetate, glycerin ethers, and 1,2,6-hexanetriol, fatty acids such as formic acid, acetic acid, propionic acid, butyric acid, isobutyric acid, isovaleric acid, and lactic acid, nitride compounds such as formamide, N,N-dimethyl formamide, acetamide, and acetonitrile, and sulfur compounds such as dimethyl sulfoxide.

Among these organic solvents, methylisobutyl ketone, methylethyl ketone, cyclohexanone, acetone, toluene, xylene, ethyl acetate, 1-penanol and the like are particularly preferable. To control an aggregation property, alcohol-based or polyhydric alcohol-based solvents may be appropriately mixed into the organic solvent for use. These organic solvents may be used singly or in combination. The total content of the organic solvent in the coating liquid is preferably in the range of 20 wt % to 90 wt %, more preferably in the range of 30 wt % to 80 wt %, and still more preferably in the range of 40 wt % to 70 wt %. To stabilize the surface texture of the light scattering layer, a solvent having a boiling point lower than 100° C. and a solvent having a boiling point equal to or higher than 100° C. are preferably used together.

Curing of Light Scattering Layer

The light scattering layer can be formed by coating the support with the coating liquid, performing irradiation with light, irradiation with electron beams, heat treatment, or the like to cause a cross-linking reaction or a polymerization reaction. When UV rays are radiated, UV rays emitted from a light source such as an ultra-high pressure mercury lamp, a high pressure mercury lamp, a low pressure mercury lamp, a carbon arc, a xenon arc, and a metal halide lamp can be used. The curing by UV rays is preferably performed in the atmosphere with an oxygen concentration equal to or less than 4 mass %, more preferably with an oxygen concentration equal to or less than 2 mass %, and still more preferably with an oxygen concentration equal to or less than 0.5 mass % through the nitrogen purging or the like.

A method of preparing a scattering support can be used in addition to the above-mentioned aspect.

As a manufacturing method thereof, a method of changing the surface texture through the above-mentioned manufacturing method or a method of giving an internal scattering property can be used.

Examples of the method of controlling the surface texture and the internal scattering property include stacking casting methods such as a co-casting method (multilayer-simultaneous casting) or a successive casting method in forming a cellulose film as described below.

In these methods, as described in JP2010-237339A, by preparing plural types of layer-forming materials having the same resin as a binder and simultaneously or successively stacking a core layer serving as a core of the support and a surface layer forming the surface, it is possible to provide a member incorporated into a body using the same kind of resin while independently controlling the core layer and the surface layer.

Display Unit

The display unit in the stereoscopic image display device according to the invention includes a liquid crystal cell and a polarizing plate on at least the viewing side of the liquid crystal cell. Preferably, the polarizing plate is disposed on the viewing side of the liquid crystal cell and the opposite side thereof (corresponding to a backlight side when the backlight is disposed).

Polarizing Plate

The polarizing plate includes a polarizing film and protective films disposed on both sides thereof. The surface member according to the invention is preferably used as the protective film on the viewing side of the polarizing film which is on the viewing side of the liquid crystal cell.

The polarizing film of the polarizing plate is not particularly limited and known ones can used. Examples thereof include an iodine-based polarizing film, a dye-based polarizing film using two-color dyes, and a polyene-based polarizing film. The iodine-based polarizing film and the dye-based polarizing film are generally formed out of a polyvinyl alcohol-based film. The thickness of the polarizing film can be set to any thickness of typical polarizing plates without any limitation.

The examples of the support of the surface member can be used as the protective film of the polarizing plate.

Liquid Crystal Cell

Liquid crystal cells with various display modes can be used in the invention. Various modes such as TN (Twisted Nematic), IPS (In-Plane Switching), FLC (Ferroelectric Liquid Crystal), AFLC (Anti-ferroelectric Liquid Crystal), OCB (Optically Compensatory Bend), STN (Supper Twisted Nematic), VA (Vertically Aligned) and HAN (Hybrid Aligned Nematic) can be preferably used as the display modes.

### EXAMPLES

The invention will be described in more detail below with reference to examples. The scope of the invention is not limited to the following specific examples.

### Example 1-1

26.64 parts by weight of pentaerythritol triacrylate (product name PET-30 made by Nippon Kayaku Co., Ltd., with a refractive index of 1.53) which is an UV-curable resin, 1.44 parts by weight of a mixture (DPHA) of dipentaerythritol pentaacrylate and dipentaerythritol hexaacrylate (made by Nippon Kayaku Co., Ltd., with a refractive index of 1.51) which are the same kind of UV-curable resin, 2.88 parts by weight of an acryl-based polymer (made by Mitsubishi Rayon Co., Ltd., with a molecular weight of 75,000), 1.37 parts by weight of Irgacure 184 (product name, made by Chiba Specialty Chemicals Co., Ltd.) which is a photo-curable initiator, 1.49 parts by weight of acryl-styrene beads (made by Soken Chemical &Engineering Co., Ltd., with a particle diameter of 3.5 μm and with a refractive index of 1.55) as first light-transmitting particulates, 4.64 parts by weight of styrene beads (made by Soken Chemical &Engineering Co., Ltd., with a particle diameter of 3.5 μm and with a refractive index of 1.60) as second light-transmitting particulates, 0.046 parts by weight of surfactant R-30 (product name, made by DIC Co., Ltd.), 6.19 parts by weight of organosilane compound KBM-5103 (product name, made by Shin-Etsu Chemical Co., Ltd.), 38.71 parts by weight of toluene, and 16.59 parts by weight of cyclohexanone were sufficiently mixed and adjusted as a coating liquid. This coating liquid is filtered through the use of a filter formed of polypropylene with a pore diameter of 30 μm to prepare Coating Liquid 1.

A triacetyl cellulose film (TD80U: product name, made by Fuji Film Co., Ltd.) with a thickness of 80 μm was wound in a roll shape, Coating Liquid 1 prepared in the above-mentioned process was applied to the resultant with a dry thickness of 7 μm, the solvent was dried at 110° C. for 1 minute, and UV rays were applied thereto at 55 mJ/cm² under the nitrogen purging (with an oxygen concentration equal to or less than 0.1%) to cure the resultant, whereby a light scatting layer was formed. The surface haze of the resultant film was 32%, the internal haze was 13%, and the total haze was 45%.

### Example 1-2

19.1 parts by weight of pentaerythritol triacrylate (product name PET-30 made by Nippon Kayaku Co., Ltd., with a refractive index of 1.53) which is the same kind of UV-curable resin, 19.1 parts by weight of an UV-curabe resin Viscoat 360 (made by Osaka Organic Chemical Industry Ltd., with a refractive index of 1.50), 1.5 parts by weight of Irgacure 127 (product name, made by Chiba Specialty Chemicals Co., Ltd.) which is a photo-curable initiator, 12.0 parts by weight of cross-linked acryl-styrene beads (made by Soken Chemical &Engineering Co., Ltd., with a particle diameter of 8 μm and with a refractive index of 1.555) as first light-transmitting particulates, 12.0 parts by weight of cross-linked acryl beads (made by Soken Chemical &Engineering Co., Ltd., with a particle diameter of 8 μm and with a refractive index of 1.50) as second light-transmitting particulates, 3.6 parts by weight of cellulose acetate butylrate as a viscosity control agent, 1.1 parts by weight of a fluorine-based surfactant, 17.1 parts by weight of methylisobutyl ketone, and 14.7 parts by weight of methylethyl ketone were sufficiently mixed and adjusted as a coating liquid. This coating liquid is filtered through the use of a filter formed of polypropylene with a pore diameter of 30 μm to prepare Coating Liquid 2.

A triacetyl cellulose film (TD80U: product name, made by Fuji Film Co., Ltd.) with a thickness of 80 μm was wound in a roll shape, Coating Liquid 2 prepared in the above-mentioned process was applied to the resultant with a dry thickness of 15 μm, the solvent was dried, and UV rays were applied thereto at 100 mJ/cm² under the nitrogen purging to cure the resultant, whereby a light scatting layer was formed.

The surface haze of the resultant film was 4%, the internal haze was 22%, and the total haze was 26%.

### Examples 1-3 to 1-11 and Comparative Examples 1-1 to 1-3

An example which was evaluated without using the surface member in the following evaluation was defined as Comparative Example 1-1.

In Examples 1-3 to 1-11 and Comparative Examples 1-2 to 1-3, the films having the haze values shown in Table 1, which were obtained by changing the type of the binder used in the light scattering layer, the refractive index and the particle diameter of the particles to be added, and the thickness to be formed, were acquired as the surface members.

The surface members acquired through the above-mentioned method were bonded to monitors of “3D Digital Camera W3” which is a stereoscopic image display device including a lenticular layer, made by Fuji Film Co., Ltd., with an adhesive and were evaluated using the following evaluation criterion.

Evaluation

By causing the monitor to display a stereoscopic image and causing 40 persons to observe the image, the Evaluation was functionally carried out in the following five steps with a stereoscopic effect of the image as a “3D effect” and with a glare effect as unpleasantness due to a moiré pattern or periodic brightness and darkness as a “moiré effect”. The evaluations of the total persons were shown in Table 1 as the maximum frequency evaluation result. When both the 3D effect and the glare intensity are equal to or higher than 2, it was determined to cause no practical problem.
5: Excellent
4: Very good
3: Good
2: Allowable
1: Poor (not-allowable)

The surface haze, the internal haze, the total haze, and the evaluation results are shown in Table 1. The haze values of the hazes were measured through the above-mentioned method.

TABLE 1

| | Surface | Internal | Total | 3D | Moire |
|---|---|---|---|---|---|
| | haze (%) | haze (%) | haze (%) | effect | effect |
| Example 1-1 | 32 | 13 | 45 | 2 | 5 |
| Example 1-2 | 4 | 22 | 26 | 3 | 3 |
| Example 1-3 | 1 | 7.5 | 8.5 | 5 | 2 |
| Example 1-4 | 1.6 | 10.6 | 12.2 | 5 | 2 |
| Example 1-5 | 1.3 | 8 | 9.3 | 5 | 2 |
| Example 1-6 | 2.3 | 7.9 | 10.2 | 5 | 2 |
| Example 1-7 | 7 | 10.3 | 17.3 | 4 | 5 |
| Example 1-8 | 15 | 28 | 43 | 2 | 3 |
| Example 1-9 | 2 | 22 | 24 | 3 | 3 |
| Example 1-10 | 3 | 11 | 14 | 5 | 2 |
| Example 1-11 | 31.6 | 2.9 | 34.5 | 2 | 5 |
| Comparative | 0 | 0 | 0 | 5 | 1 |
| Example 1-1 | | | | | |
| Comparative | 0.3 | 0.7 | 1 | 5 | 1 |
| Example 1-2 | | | | | |
| Comparative | 38 | 9.9 | 47.9 | 1 | 5 |
| Example 1-3 | | | | | |

### Example 2-1

The film 30 described in the examples of JP2010-237339 was prepared as the surface member in Example 2-1 and the evaluation was carried out in the same way as in Example 1-1.

In Examples 2-2 to 2-11 and Comparative Examples 2-1 and 2-2, films were manufactured in the same way, except that the type of dopant in the preparation of the film 30 in Example 2-1 or the particles to be added was changed, and the obtained films were evaluated.

The evaluation results are shown in Table 2.

TABLE 2

| | Surface | Internal | Total | 3D | Moire |
|---|---|---|---|---|---|
| | haze (%) | haze (%) | haze (%) | effect | effect |
| Example 2-1 | 12.2 | 5.0 | 17.2 | 4 | 5 |
| Example 2-2 | 10.6 | 2.1 | 12.7 | 5 | 4 |
| Example 2-3 | 17.1 | 2.2 | 19.3 | 4 | 5 |
| Example 2-4 | 14 | 2.9 | 16.9 | 4 | 5 |
| Example 2-5 | 20 | 4 | 24 | 3 | 4 |
| Example 2-6 | 18.2 | 5.4 | 23.6 | 4 | 5 |
| Example 2-7 | 25 | 7 | 32 | 3 | 5 |
| Example 2-8 | 22 | 2 | 24 | 2 | 5 |
| Example 2-9 | 9.5 | 15.1 | 24.6 | 4 | 3 |
| Example 2-10 | 12.4 | 17.3 | 29.7 | 4 | 3 |
| Example 2-11 | 5.7 | 23.3 | 29 | 4 | 2 |
| Comparative | 35.3 | 0.8 | 36.1 | 1 | 5 |
| Example 2-1 | | | | | |
| Comparative | 17 | 30 | 47 | 1 | 3 |
| Example 2-2 | | | | | |

It can be seen from the results of Tables 1 and 2 that it is possible to reduce the glare without deteriorating the 3D effect, by disposing the surface member having a surface haze in the range of 1% to 35% and an internal haze in the range of 0% to 30% on the surface of the viewing side.

What is claimed is:

1. A autostereoscopic image display device comprising: sequentially from a viewing side,
a surface member;
a lenticular layer; and
a display unit,
wherein the surface haze of the surface member is in the range of 1% to 35% and the internal haze of the surface member is in the range of 0% to 30%.

2. The autostereoscopic image display device according to claim 1, wherein the total haze of the surface member is in the range of 1% to 45%.

3. The autostereoscopic image display device according to claim 1, wherein the surface haze of the surface member is in the range of 3% to 25% and the internal haze is in the range of 0% to 15%.

4. The autostereoscopic image display device according to claim 1, wherein the surface member has surface unevenness.

5. The autostereoscopic image display device according to claim 1, wherein the surface member has a scattering structure including a binder and at least one kind of particles with a diameter of 1 to 20 μm and the difference in refractive index between the binder and the particles is in the range of 0.0 to 0.2.

6. The autostereoscopic image display device according to claim 1, wherein the surface member has a sea-island structure in which the difference in refractive index between domains due to phase separation is in the range of 0.02 to 0.1.

7. The autostereoscopic image display device according to claim 1, wherein the surface member further has a functional layer.

8. The autostereoscopic image display device according to claim 7, wherein the functional layer is at least one layer selected from the group consisting of an antireflection layer, an hardcoat layer, an antifouling layer, and an antistatic layer.

9. The autostereoscopic image display device according to claim 1, wherein the surface member is an optical film.

10. The autostereoscopic image display device according to claim 9, wherein the display unit includes a liquid crystal cell and a polarizing plate at least on the viewing side of the liquid crystal cell, and the optical film is a protective film of the polarizing plate on the viewing side.

11. A film for the autostereoscopic image display device including the optical film according to claim 9, wherein the optical film is a layer obtained by forming a scattering structure including a binder and at least one kind of particles with a diameter of 1 to 20 μm on a support member by coating.

12. The film for the autostereoscopic image display device according to claim 11, wherein the support member includes at least one selected from the group consisting of cellulose acylate, acrylic resin, polyester, and cycloolefin polymer.

13. The film for the autostereoscopic image display device according to claim 11, wherein the optical film further has a functional layer.

14. The film for the autostereoscopic image display device according to claim 13, wherein the functional layer is at least one layer selected from the group consisting of an antireflection layer, an hardcoat layer, an antifouling layer, and an antistatic layer.
